(19) United States
(12) Patent Application Publication
(10) Pub. No.: US 2016/0131201 A1
(43) Pub. Date: May 12, 2016

(54) TRANSMISSION HUB AND SLEEVE ASSEMBLY

(71) Applicant: GM Global Technology Operations LLC, Detroit, MI (US)

(72) Inventor: Henrique Budacs, Cotia (BR)

(21) Appl. No.: 14/857,339

(22) Filed: Sep. 17, 2015

Related U.S. Application Data
(60) Provisional application No. 62/076,845, filed on Nov. 7, 2014.

(51) Int. Cl. F16D 23/02

(52) U.S. Cl. CPC F16D 23/02

(57) ABSTRACT

An assembly includes a hub and a sleeve in which the hub resides. The hub includes a first set of teeth and the sleeve includes a second set of teeth that engages with the hub's first set of teeth. The sleeve includes at least one tooth that has a reduced height compared to the rest of the sleeve's teeth, and the hub has a set of landings with at least one landing that is shallower than the rest of the landings of the hub. The hub and sleeve are configured such that the at least one tooth of reduced height resides in the at least one shallower landing. The hub further includes a first face and a second face that has the same configuration as the first face. The combination of the same first face and second face and the reduced tooth height and shallower landing provides a hub and sleeve assembly that can be assembled in one of only six functional configurations.

### RELATED APPLICATION

The present application claims the benefit of U.S. Provisional Patent Application No. 62/076,845, filed on Nov. 7, 2014.

The entire contents of the above application are incorporated herein by reference.

### FIELD

The present disclosure relates to a hub and sleeve assembly for manual transmissions.

### BACKGROUND

The statements in this section merely provide background information related to the present disclosure and may or may not constitute prior art.

A typical motor vehicle transmission includes numerous components that interact with each other during the operation of the transmission. For example, a manual transmission generally includes a synchronizer system with a hub and sleeve assembly. During the manufacturing of the transmission, there is a potential that the hub and sleeve can be assembled together incorrectly.

Accordingly, there is a needs for a transmission hub and sleeve assembly that minimizes or reduces the possibility of assembling the hub and sleeve incorrectly.

### SUMMARY

The present invention provides an improved hub and sleeve assembly for manual transmissions.

Accordingly, in one aspect of the invention, an assembly includes a hub and a sleeve in which the hub resides. The hub includes a first set of teeth and the sleeve includes a second set of teeth that engages with the hub's first set of teeth. The sleeve includes at least one tooth that has a reduced height compared to the rest of the sleeve's teeth, and the hub has a set of landings with at least one landing that is shallower than the rest of the landings of the hub. The hub and sleeve are configured such that the at least one tooth of reduced height resides in the at least one shallower landing. The hub further includes a first face and a second face that has the same configuration as the first face. The combination of the same first face and second face and the reduced tooth height and shallower landing provides a hub and sleeve assembly that can be assembled in one of only six functional configurations.

In another aspect, an assembly includes a hub with a first set of teeth and a set of landings with at least one landing that is shallower than the rest of the landings of the hub, and a sleeve with a second set of teeth that engages with the first set of teeth. At least one tooth of the second set of teeth has a reduced height relative to the rest of the teeth of the second set of teeth. The at least one tooth of reduced height resides in the at least one shallower landing.

In yet another aspect, a hub with a first set of teeth and a set of landings with six landings that are shallower relative to the rest of the landings of the set of landings, and a sleeve with a second set of teeth that engages with the first set of teeth. The second set of teeth including six teeth of reduced height relative to the rest of the teeth of the second set of teeth, and each tooth of reduced height resides in a respective shallower landing.

Any of the aforementioned assemblies may be further characterized by one or any combination of the features described herein, such as, for example: the hub includes a first set of teeth and the sleeve includes a second set of teeth that engages with the first set of teeth; at least one tooth of the second set of teeth has a reduced height relative to the rest of the teeth of the second set of teeth; the hub has a set of landings with at least one landing that is shallower than the rest of the landings of the hub; the at least one tooth of reduced height resides in the at least one shallower landing; the second set of teeth includes six teeth of reduced height relative to the rest of the teeth of the second set of teeth, and the hub includes a set of landings with six landings that are shallower relative to the rest of the landings of the set of landings; each tooth of reduced height resides in a respective shallower landing; the hub and the sleeve are assembled in one of three rotational configurations; the hub includes a first face and a second face that has the same configuration as the first face; the configurations of the first face and the second face and the one of three rotational configurations provides the one of the six functional configurations; and the hub includes a bore with a set of teeth.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. Moreover, in the figures, like reference numerals designate corresponding parts throughout the views. In the drawings:

FIG. 1 is a perspective view of a hub and sleeve assembly for a manual transmission in accordance with the principles of the present invention;

FIG. 2A is a side view of the hub and sleeve assembly shown in FIG. 1;

FIG. 2B is a close-up view of the region 2B in FIG. 2A;

FIG. 3A is a perspective view of the hub;

FIG. 3B is a side view of the hub; and

FIG. 3C is a side view of the side opposite the side shown in FIG. 3B.

### DETAILED DESCRIPTION

The following description is merely exemplary in nature and is not intended to limit the present disclosure, application, or uses.

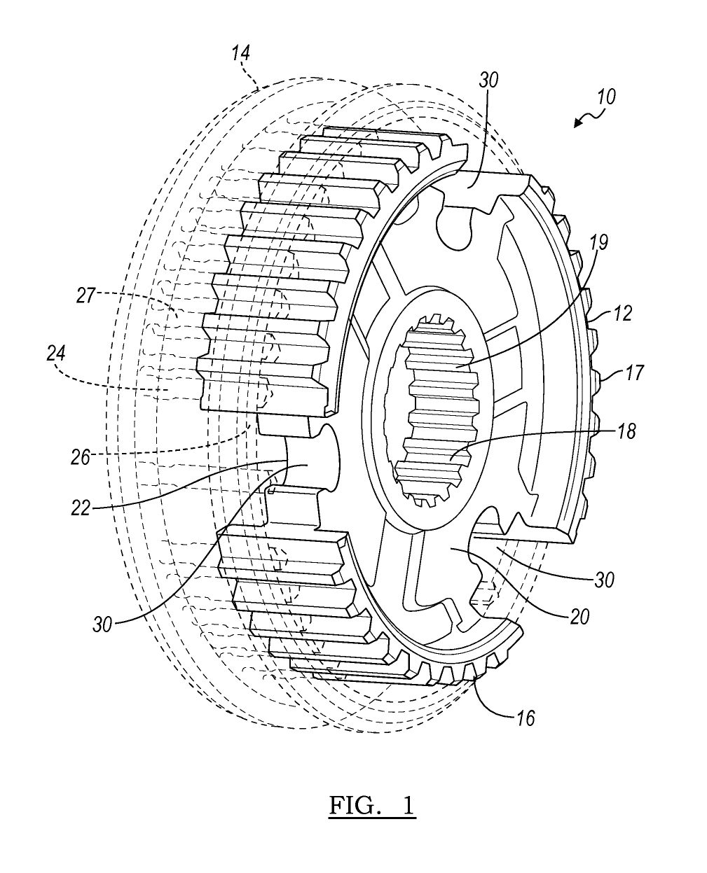

Referring now to the drawings, a hub and sleeve assembly for a manual transmission is shown in FIG. 1 and designated at 10. The hub and sleeve assembly 10 includes a hub 12 and a sleeve 14.

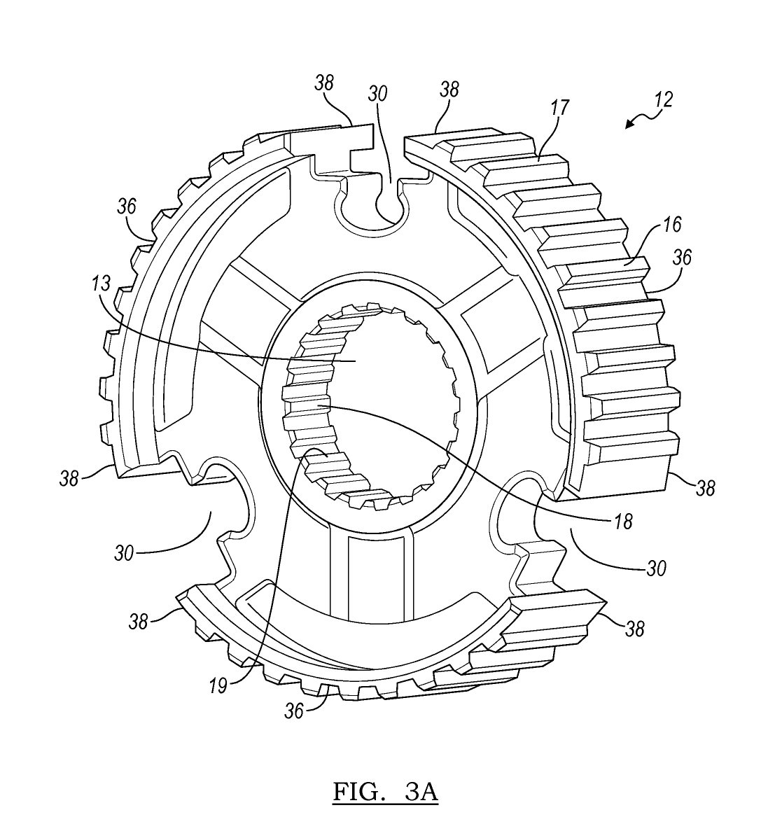

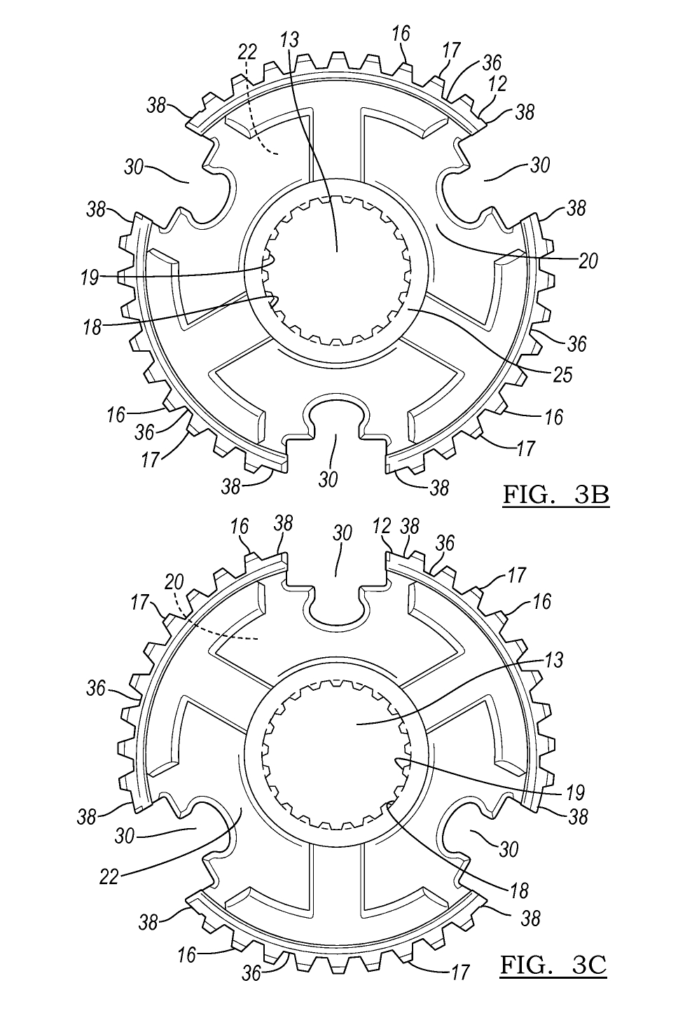

With further reference to FIGS. 3A, 3B and 3C, the hub 12 includes two identical faces 20 and 22 and a set of teeth 16 around the periphery of the hub 12. The hub 12 further includes an inner bore 13 with a set of teeth 18 that includes individual teeth 19. In the arrangement shown, the set of teeth 16 is separated into three sections separated by gaps 30. In each section, the set of teeth 16 includes individual teeth 17 that span the set of teeth 16. Between each tooth 17 is a landing 36. At the ends of each section of teeth 16, however, is a landing 38 that is shallower than the landing 36.

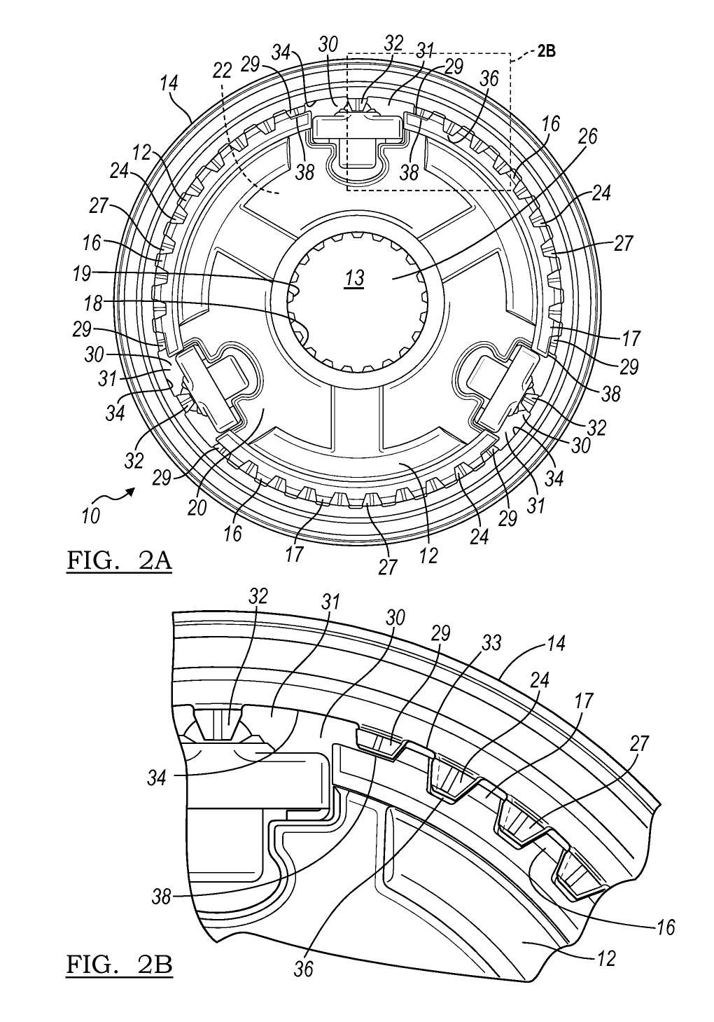

With particular reference to FIGS. 2A and 2B, the sleeve 14 includes a bore 26 and a set of teeth 24 that extend inward from an interior surface 34. The set of teeth 24 is separated into three sections by gaps 31, and an isolated tooth 32 is positioned in the middle of each gap 31. In each section, the set of teeth 24 includes individual teeth 27 that are spaced apart by landings 33.

When the hub 12 and sleeve 14 are assembled, the teeth 27 of the sleeve 14 engage cooperatively with the teeth 17 of the hub 12. More specifically, the teeth 27 of the sleeve 14 reside within the landings 36 of the hub 12 and the teeth 16 of the hub 12 reside in the landings 33 of the sleeve 14. The outer most teeth of each section of the set of teeth 24 are teeth 29 that also extend inwardly from the interior surface 34 but at a height that is less than the height of the teeth 27 relative to the surface 34. The teeth 29 are configured to reside in the shallower landings 38 of the hub 12 when the hub 12 and the sleeve 14 are assembled together.

When the hub 12 is assembled with the sleeve 14, the two components can be assembled with either the face 20 or the face 22 of the hub 12 facing the transmission, so that the other face faces the engine. Moreover, since each tooth 29 of the sleeve 14 can only reside in the landings 38 of the hub 12, there are only three possible rotational configurations that the hub 12 can be assembled with the sleeve 14. Hence there are a total of only 6 possible configurations that the hub 12 and the sleeve 14 can be assembled together.

The description of the invention is merely exemplary in nature and variations that do not depart from the gist of the invention are intended to be within the scope of the invention. Such variations are not to be regarded as a departure from the spirit and scope of the invention.

What is claimed is:

1. An assembly comprising:
a hub; and
a sleeve configured to reside within the hub,
wherein the hub and sleeve are assembled in one of six functional configurations.

2. The assembly of claim 1 wherein the hub includes a first set of teeth and the sleeve includes a second set of teeth that engages with the first set of teeth.

3. The assembly of claim 2 wherein at least one tooth of the second set of teeth has a reduced height relative to the rest of the teeth of the second set of teeth.

4. The assembly of claim 3 wherein the hub has a set of landings with at least one landing that is shallower than the rest of the landings of the hub.

5. The assembly of claim 4 wherein the at least one tooth of reduced height resides in the at least one shallower landing.

6. The assembly of claim 2 wherein the second set of teeth includes six teeth of reduced height relative to the rest of the teeth of the second set of teeth, and the hub includes a set of landings with six landings that are shallower relative to the rest of the landings of the set of landings.

7. The assembly of claim 6 wherein each tooth of reduced height resides in a respective shallower landing.

8. The assembly of claim 7 wherein the hub and the sleeve are assembled in one of three rotational configurations.

9. The assembly of claim 7 wherein the hub includes a first face and a second face that has the same configuration as the first face.

10. The assembly of claim 9 wherein the configurations of the first face and the second face and the one of three rotational configurations provides the one of the six functional configurations.

11. The assembly of claim 1 wherein the hub includes a bore with a set of teeth.

12. An assembly comprising:
a hub with a first set of teeth and a set of landings with at least one landing that is shallower than the rest of the landings of the hub; and
a sleeve with a second set of teeth that engages with the first set of teeth, at least one tooth of the second set of teeth has a reduced height relative to the rest of the teeth of the second set of teeth,
wherein the at least one tooth of reduced height resides in the at least one shallower landing.

13. The assembly of claim 12 wherein the hub and sleeve are assembled in one of six functional configurations.

14. The assembly of claim 13 wherein the hub and the sleeve are assembled in one of three rotational configurations.

15. The assembly of claim 14 wherein the hub includes a first face and a second face that has the same configuration as the first face.

16. The assembly of claim 15 wherein the configurations of the first face and the second face and the one of three rotational configurations provides the one of the six functional configurations.

17. An assembly comprising:
a hub with a first set of teeth and a set of landings with six landings that are shallower relative to the rest of the landings of the set of landings; and
a sleeve with a second set of teeth that engages with the first set of teeth, the second set of teeth including six teeth of reduced height relative to the rest of the teeth of the second set of teeth,
wherein each tooth of reduced height resides in a respective shallower landing.

18. The assembly of claim 17 wherein the hub and the sleeve are assembled in one of three rotational configurations.

19. The assembly of claim 18 wherein the hub includes a first face and a second face that has the same configuration as the first face.

20. The assembly of claim 19 wherein the configurations of the first face and the second face and the one of three rotational configurations provides one of six functional configurations for the assembly of the hub and the sleeve.
